(19) United States
(12) Patent Application Publication
(10) Pub. No.: US 2019/0001700 A1
(43) Pub. Date: Jan. 3, 2019

(54) COALESCING FROTHY FLUIDS

(71) Applicant: Hewlett-Packard Development Company, L.P., Houston, TX (US)

(72) Inventors: Anthony D Studer, Albany, OR (US); Robert S Wickwire, Corvallis, OR (US); David J Benson, Albany, OR (US)

(21) Appl. No.: 16/064,231

(22) PCT Filed: Apr. 11, 2016
(86) PCT No.: PCT/US2016/026964

§ 371 Date: Jun. 20, 2018

(51) Int. Cl. B41J 2/19; B01D 36/00; B41J 2/175

(52) U.S. Cl. CPC B41J 2/19; B41J 2/17563; B01D 36/001

(57) ABSTRACT

In one example in accordance with the present disclosure a device for coalescing a frothy fluid is described. The device includes a housing and a filter disposed within the housing. An outside surface of the filter is separated from an inside surface of the housing by a gap. The filter is sealed against the housing to enclose the gap. An inlet port of the device drives incoming frothy fluid through the gap. An outlet port of the device drains liquid coalesced as bubbles in the frothy fluid dissipate and an air vent allows air to escape the gap.

### BACKGROUND

Froth is a common occurrence in many fluids. Froth is a mass of bubbles in a fluid, or on the surface of the fluid. Froth can form as air is incorporated into the fluid. For example, in ink printing systems, as air is introduced into an ink reservoir to maintain pressure, froth may form in the corpus of the ink or on a surface of the ink. Froth is also found in other fluids, for example detergents or liquid soaps. Such froth may inhibit the operations of a system that processes fluids that are susceptible to froth formation.

### BRIEF DESCRIPTION OF THE DRAWINGS

The accompanying drawings illustrate various examples of the principles described herein and are a part of the specification. The illustrated examples are given merely for illustration, and do not limit the scope of the claims.

FIGS. 1A and 1B are views of a device for coalescing a frothy fluid, according to one example of the principles described herein.

FIG. 2 is a front cross-sectional view of a device for coalescing a froth fluid, according to one example of the principles described herein.

FIG. 3 is a top view of a device for coalescing a frothy fluid, according to one example of the principles described herein.

FIG. 4 is a view of the gap between a cylindrical filter and a cylindrical housing of the device for coalescing a frothy fluid, according to one example of the principles described herein.

FIG. 5 is a flowchart of a method for forming a device for coalescing a frothy fluid, according to one example of the principles described herein.

FIG. 6 is a flowchart of a method for forming a device for coalescing a frothy fluid, according to another example of the principles described herein.

FIGS. 7A-7C are diagrams of a lid of the device for coalescing a frothy fluid, according to one example of the principles described herein.

Throughout the drawings, identical reference numbers designate similar, but not necessarily identical, elements.

### DETAILED DESCRIPTION

As described above, froth may be found in many fluids. For example, in printing systems, a desired backpressure may be desirable in an ink printhead. To maintain this pressure, air is introduced into the printhead. The mixture of the ink and air generates froth within the printhead. While specific reference is made to froth in an ink printhead, such froth can exist in any fluid-processing system. For example, some devices such as industrial cleaning devices use liquid detergent to clean components of the system. These devices similarly contain a froth layer due to the incorporation of air, surfactants, or other components.

Such froth can impact the functionality of the system. For example, in an ink system, froth may reduce the accuracy of certain sensors such as an ink level gauge or a sensor that indicates that the system is out of ink. The accuracy of these sensors and gauges impacts customer satisfaction, system performance, and system reliability. More specifically, the froth present in an ink supply could prematurely trigger an out of ink sensor. Such a premature triggering of the sensor could lead to the replacement of an ink supply prior to its exhaustion, which is an inefficient use of ink as well as a loss of revenue for a producer, and may create an impression on the customer that an ink supply drains sooner than it actually does. In some cases, such a premature triggering of an ink sensor could also lead to failure of the printing system.

Some systems have implemented a batch froth dissipation system wherein froth accumulates and dissipates over time and is gravity fed back into the system. However, this system relies on time to dissipate the froth, and accordingly a lag is introduced between froth accumulation and coalescence. Such a lag, in addition to being inefficient, also leads to erroneous fluid level readings.

Accordingly, the present specification describes devices and methods for coalescing a frothy fluid into coalesced fluid and air. Specifically, the present specification describes a system that continuously, and not in a batched, or periodic fashion, coalesces a frothy fluid in real-time. In so doing, the function of the corresponding system in general is improved, specifically the accuracy of system sensors is improved, which leads to improved system performance, increased customer satisfaction, and improved fluid efficiency. Still further, the present devices and methods are oriented to promote the dissipation of froth, rather than just allowing time to eventually break down the froth bubbles.

In addition to those situations mentioned above, froth may impact the fluid-processing systems in other ways. Accordingly, a real-time, quick, and continuous method for reducing froth in a liquid would enhance the operation of such fluid-processing systems in any number of ways by removing froth more quickly and continuously without having to rely on the periodic opening and closing of valves and the use of electrical or other mechanical sensors that increase the complexity of a system.

More specifically, the present specification describes a device for coalescing a frothy fluid. The device includes a housing and a filter disposed within the housing. An outside surface of the filter is separated from an inside surface of the housing by a gap and the filter seals against the housing to enclose the gap. An inlet port of the housing drives incoming frothy fluid through the gap. An outlet port drains coalesced fluid produced as bubbles in the frothy fluid dissipate and a first air vent allows air to escape the gap.

The present specification also describes a method for forming a device for coalescing a frothy fluid. In the method, a cylindrical filter is placed inside a cylindrical housing such that an outside diameter of the cylindrical filter is separated by an annular gap from an inside diameter of the cylindrical housing. A frothy fluid travels upward through the annular gap and is separated into coalesced fluid and air. The gap is enclosed except for a first air vent to allow air to escape the gap.

The present specification also describes a device for coalescing a frothy fluid. The device includes a cylindrical housing and a cylindrical filter disposed within, and separated from, the cylindrical housing to form an enclosed annular gap. The cylindrical filter is to dissipate bubbles in the frothy fluid and allow passage of coalesced fluid to an interior of the cylindrical filter. An inlet port on the housing drives incoming frothy fluid perpendicular to pores in the filter and upwards through the enclosed annular gap and an outlet port allows drainage of the coalesced fluid. A first air vent allows air to escape the enclosed annular gap. The device also includes a lid having a second air vent to allow the escape of air produced during a defrothing of the frothy fluid.

Using such a device for coalescing a frothy fluid 1) allows for real-time, and not delayed, batched, or periodic, dispersal of froth from a fluid; 2) is passive in that it doesn't rely on sensors, or other moving components to dissipate the froth; 3) actively promotes the dissipation of froth, rather than allowing the froth to dissipate as merely a function of time; 4) improves froth-dissipation efficiency thereby enhancing the operation of a system that processes a fluid prone to froth accumulation; 5) improves the accuracy of certain system sensors, and 6) accommodates faster operations of a fluid-processing system by providing a continuous real-time defrothing of a frothy fluid. However, it is contemplated that the devices disclosed herein may provide useful in addressing other matters and deficiencies in a number of technical areas. Therefore the systems and methods disclosed herein should not be construed as addressing any of the particular matters.

As used in the present specification and in the appended claims, the term “a number of” or similar language is meant to be understood broadly as any positive number including 1 to infinity; zero not being a number, but the absence of a number.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language indicates that a particular feature, structure, or characteristic described in connection with that example is included as described, but may not be included in other examples.

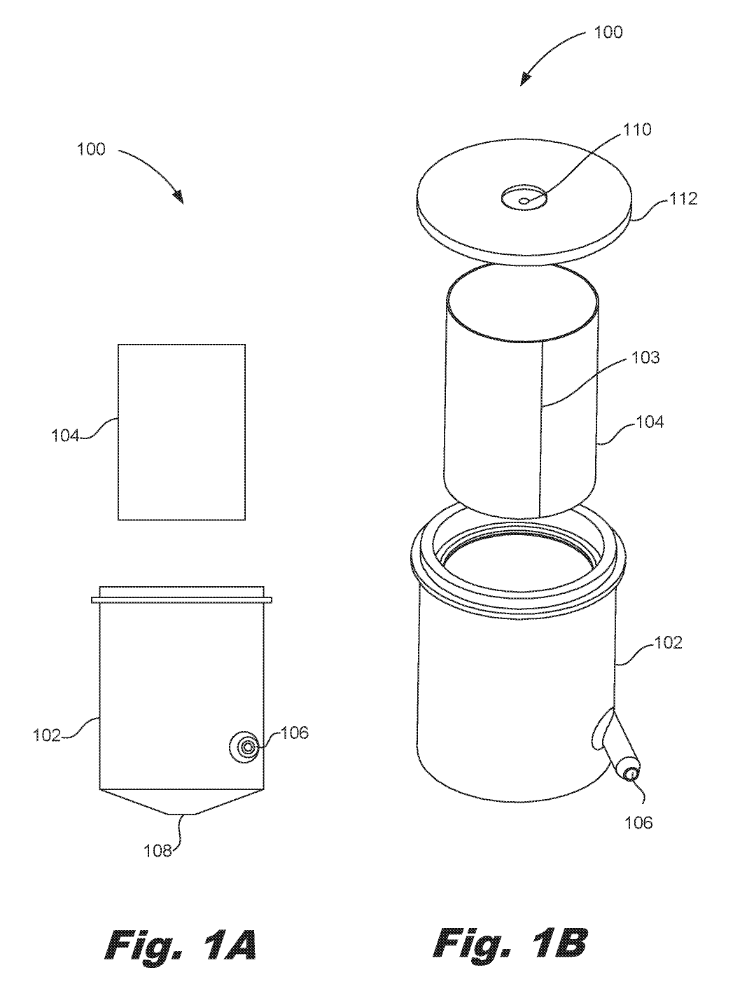

Turning now to the figures, FIGS. 1A and 1B are views of a device (100) for coalescing a frothy fluid, according to one example of the principles described herein. More specifically, FIG. 1A is a front view of the device (100) without a lid (112) and FIG. 1B is an exploded isometric view of the device (100) including a lid (112). The device (100) includes a housing (102). The housing (102) is a receptacle of incoming frothy fluid and houses the filter (104) which is used to dissipate the bubbles that form the froth. While FIG. 1 depicts a cylindrical housing (102), the housing (102) may be any shape or size. A cylindrical housing (102) has a large surface area to volume ratio such that a large amount of filter (104) space is available relative to the volume occupied by the filter (104).

The device (100) also includes a filter (104) which is used to dissipate bubbles in the frothy fluid. When disposed within the housing (102), the filter (104) is separated from the housing (102). In other words, there is a gap between the outside surface of the filter (104) and the inside surface of the housing (102), it is within this gap that the frothy fluid travels through the device (100). For example, as frothy fluid enters the inlet port (106), the fluid is driven around the diameter of the filter (104), i.e., perpendicular to pores in the filter (104) and upwards. In the example where the housing (102) and filter (104) are cylindrical, the path of the frothy fluid is helical beginning at the inlet port (106). As will be illustrated in other figures, the filter (104) is sealed against the housing (102) such that the gap is enclosed.

The filter (104) aids in the dissipation of froth bubbles as well as draining the coalesced fluid. For example, as the frothy fluid is driven up and around the filter (104) various characteristics of the device (100) act to cause the bursting of the bubbles in the froth. As the bubbles break down, they are separated into coalesced fluid and air. The coalesced fluid flows through the pores in the surface of the filter (104). The air escapes the gap through a first air vent, and if, as depicted in FIG. 1B the device (100) includes a lid (112), a second air vent (110). The use of the lid (112) and second air vent (110) allow for the tuning of the internal pressure of the device (100), which affects the flow of the printing fluid out of the outlet port (108).

The size of the gap may actively promote the dissipation of froth bubbles, rather than having the defrothing be solely a function of time. For example, in accumulation systems, frothy fluid is allowed to accumulate, but dissipation occurs naturally. By comparison, in the present device (100) dissipation of the froth is encouraged. For example, the gap is sized such that individual bubbles stack on top of one another between the inside surface of the housing (102) and the outside diameter of the filter (104). Stacking the bubbles single-file as such, weakens the bubbles, dries them out, and therefore increases their rate of dissipation. Furthermore, the gap between the filter (104) and the housing (102) may be such that pressure is exerted on the bubble walls, further encouraging collapse of the bubbles. Moreover, the path of the bubbles through the gap, and upwards, causes the bubbles to dry up weaken, and burst. As a result, the present device (100), and specifically the driving of the frothy fluid between a narrow gap, increases the rate of dissipation of the bubbles of the frothy fluid.

Coalesced fluid and air are generated from the dissipation of such bubbles. The coalesced fluid flows through the filter (104) to the center of the filter (104). An outlet port (108) of the device (100) allows the coalesced fluid to drain out of the device (100) as the bubbles in the frothy fluid dissipate. Accordingly, the outlet port (108) may be disposed on a lowest point of drainage on the housing (102), for example on a bottom surface of the housing (102). This drained coalesced liquid can then be returned to the system of which the device (100) is a part to be used for its intended purpose. For example, ink may be returned for use in printing on a print media.

The filter may be made out of any material. For example, the filter (104) may be formed of metal. In forming a cylindrical filter (104) out of metal, a flat piece of metal can be rolled into a cylindrical shape and welded. Thus, a seam (103) is formed on the filter (104). This seam (103) is circumferentially removed from the inlet port (106) to increase the effect of the filter (104) in defrothing the frothy fluid before reaching the seam (103). In other words, the seam (103), being a disturbance in the flow path of the frothy fluid, may generate additional bubbles, thus countering the effect of the device (100). Thus, by placing the seam (103) far away, for example at least 180 degrees circumferentially from the inlet port (106) in the direction of fluid flow, a greater surface area of the filter (104) is used before the effects of the seam (103) impact the system.

As described above, the filter (104) includes pores for allowing coalesced fluid to pass through. The sizing, density, and shape of these pores is selected based on the type of fluid passing through. For example, one filter (103) may be desirable for one application where larger pore sizes, and a lighter density of the pores is desired. In another example, another filter (104) that has smaller pores that are more densely packed, may be desirable. Moreover, the size of the filter (104) which may be defined by a height and diameter of the filter (104) may be selected based on the application. For example, if a greater flow of fluid is anticipated, the filter (104) may be taller and/or have a wider diameter to facilitate the increased flow. Accordingly, filter (104) characteristics such as size, pore size, and pore density can be selected to meet differing device (100) operating characteristics such as a more aggressive recharge, accommodating different froth characteristics, etc.

Still to this point, for a given operation pressure and a given operating fluid, the filter (104) screen mesh size may be selected such that it has a higher bubble pressure than a pressure to move the froth between the filter (104) mesh. If not done, then instead of coalescing the bubbles, the filter (104) would merely create bubbles. Likewise, based on the fluid properties, the area of the filter (104) mesh may be sized to support the flow of fluid to be used throughout the system in which the device (100) is installed. If the filter (104) area is too small, then it will not work real-time, which would result in a decrease in efficiency.

The device (100) also includes an inlet port (106) disposed on the housing (102) to drive incoming frothy fluid through the aforementioned gap. In one example, the fluid is ink. For example, as ink is used during printing, it is replaced with air that is bubbled in. The bubbling in of air generates a froth in, or on the surface of, the ink. This frothy ink is received at the device (100) via the inlet port (106). While specific reference is made to frothy ink, the device (100) may be used to coalesce any frothy fluid such as detergents, or water with any number of components that generate froth within the water such as surfactants. As depicted in the Figures, in some examples, the inlet port (106) is disposed at the bottom of the housing (102) aligned with a bottom of the filter (104) that is disposed within the housing (102). Doing so increases the portion of the surface area of the filter (104) that is used to defroth the frothy fluid. For example, if the inlet port (106) were aligned with a middle of the filter (104), or at the top, then a reduced portion of the filter (104) mesh, the portion above the inlet port (106), is used real-time.

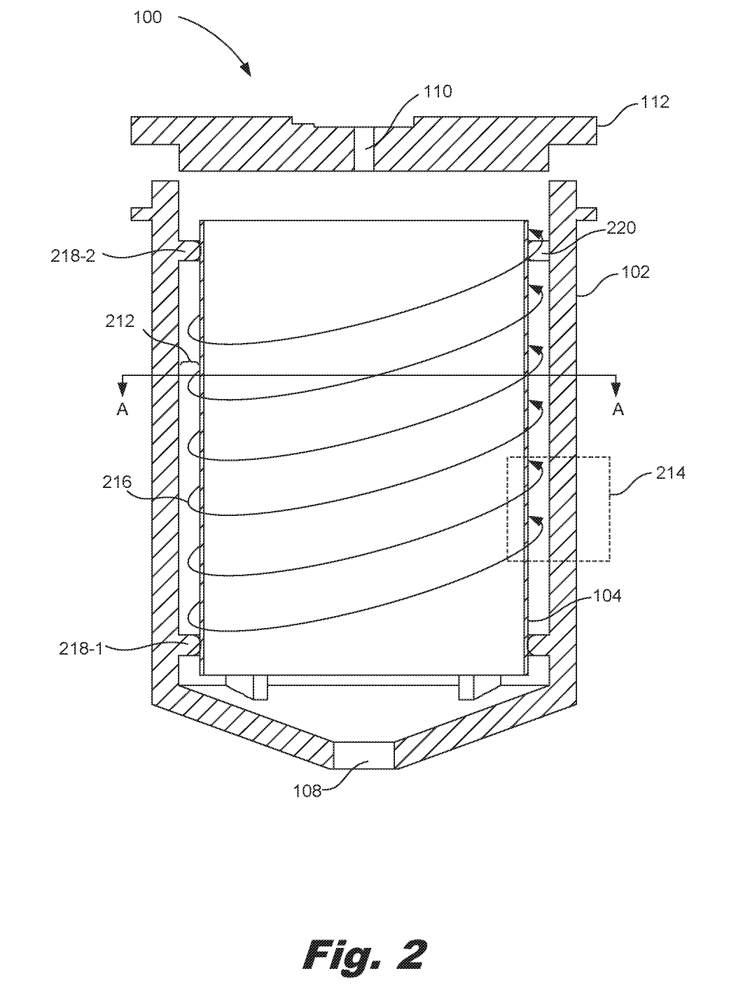

To manage the air resulting from the dissipation of froth bubbles, the device (100) also includes at least one air vent to allow air to escape as the froth bubbles dissipate. Specifically, the filter (104) is sealed against the housing (102) as clearly indicated in FIG. 2. The sealing of the filter (104) against the housing (102) encloses the gap. A first air vent allows air to escape the gap.

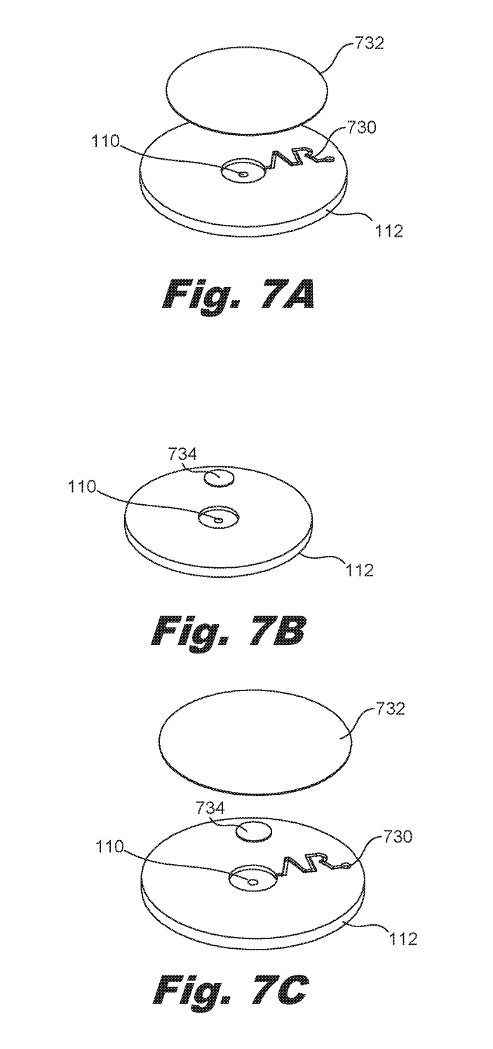

In some examples, as depicted in FIG. 1B, the device (100) includes a lid (112) that caps the housing. Disposed on the lid (112) is a second air vent (110). Examples of the lid (112), and specifically the second air vent (110), are provided below in connection with FIGS. 7A-7C. As will be described below, based on the characteristics of the system, the device (100) may be operated at atmospheric pressure, or a desired pressure greater than, or less than atmospheric pressure may be maintained in the device (100).

The device (100) as described herein allows for the continuous and automatic removal of gas from a flowing stream of mixed fluid and gas of varying concentration ratios. It is continuous in that it does not rely on the periodic dispersal of the gas or froth in a liquid, but rather froth bubbles are continuously dissipated as the frothy fluid follows a path, such as a helical path, upwards and through the gap. It is automatic in that there are no electrical stimuli that activate a dispersal mechanism of the device (100). For example, a batch system accumulates gas/air in a storage volume and then periodically removes the accumulated gas/air by the use of active valves, pumps or vacuum sources that are controlled by some control apparatus. However, the present device (100) doesn't use such valves, pumps, or control apparatus to dissipate gas from a liquid. The present system operates based on the energy created when fluid flows into the inlet port (106).

Still further, the real-time dissipation, i.e., continuous, of froth bubbles, allows the device (100) to keep up with the demands of systems incorporating the device (100), which systems may necessitate increased fluid flow rates, and increased froth removal quantities. For example, in a printing environment, faster print speeds and higher quality inks may generate greater amounts of froth. The continuous, real-time defrothing of the fluid and a device (100) orientation that promotes, or encourages froth dissipation, allows for the device (100) to meet the demands of increased fluidic system operation. Even further, the device (100) as described herein is an efficient, low-cost, space-efficient froth coalescing device, which delivers a known volume of coalesced fluid into a fluid reservoir.

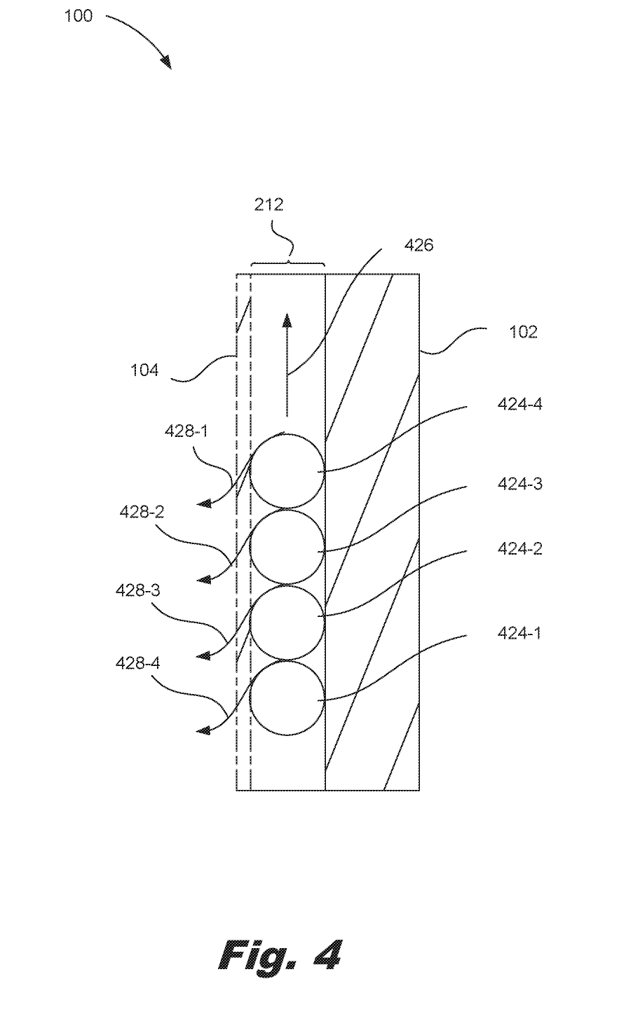

FIG. 2 is a front cross-sectional view of a device (100) for coalescing a frothy fluid, such as ink, according to one example of the principles described herein. As described above, when inserted into the housing (102), a gap (212) exists between the housing (102) wall and the filter (104). As frothy fluid travels into the housing (102), it is driven up and circumferentially around the filter (104) through the gap (212) as indicated by the arrow (216). While traveling, the froth bubbles are compressed between the housing (102) and the filter (104), which forces the bubbles to combine and burst as they abrade against the surface of the filter (104). As the froth bubbles collapse, they release the fluid between the bubbles as well as the fluid of the bubble shells. The coalesced fluid travels through the filter (104) and is gravity fed to the outlet port (108), which outlet port (108) is disposed on an interior of the cylindrical filter (104). As this fluid drains through the filter (104), the remaining frothy fluid starts to dry out as it continues to travel upward and circumferentially. The frothy fluid continues in this pattern until all bubbles are coalesced and separated into their two parts i.e., coalesced fluid and air. The coalesced fluid can then be recycled to the system in which the device (100) is inserted. FIG. 4 depicts a zoomed in area of the dashed box (214) to further illustrate the motion of the bubbles through the filter (104).

FIG. 2 also depicts the second air vent (110) disposed in the lid (112). Note that in the device (100) there are two exits for the frothy fluid. The first is through the filter (104), which is used by the coalesced liquid. The second is through the second air vent (110), which is used by the gas/air generated as the froth bubbles pop.

To form the gap (212) between the housing (102) and the filter (104), the housing (102) may include a pair of annular ridges (218-1, 218-2). The annular ridges (218) extend inwards from the inside surface of the housing (102). These annular ridges (218) interfere with the filter (104) to 1) hold the filter (104) in place and 2) seal the gap (212) at the top and bottom to enclose the gap (212). While specific reference is made to annular ridges (218) that are integral to the housing (102) being used to form and seal the gap (212), other mechanisms may be used as well.

To allow the air to escape the gap (212) as fluid is coalesced, one of the annular ridges (218), for example, the top annular ridge (218-2), includes a slot defining the first air vent (220) through which the air passes on its way to the second air vent (110). The first air vent (220) may be circumferentially located at least 180 degrees from the inlet port (FIG. 1, 106). Doing so enhances the operation of the device (100) as the bubbles are exposed to a larger surface of the filter (FIG. 1, 104) before being allowed to escape through the first air vent (FIG. 2, 220).

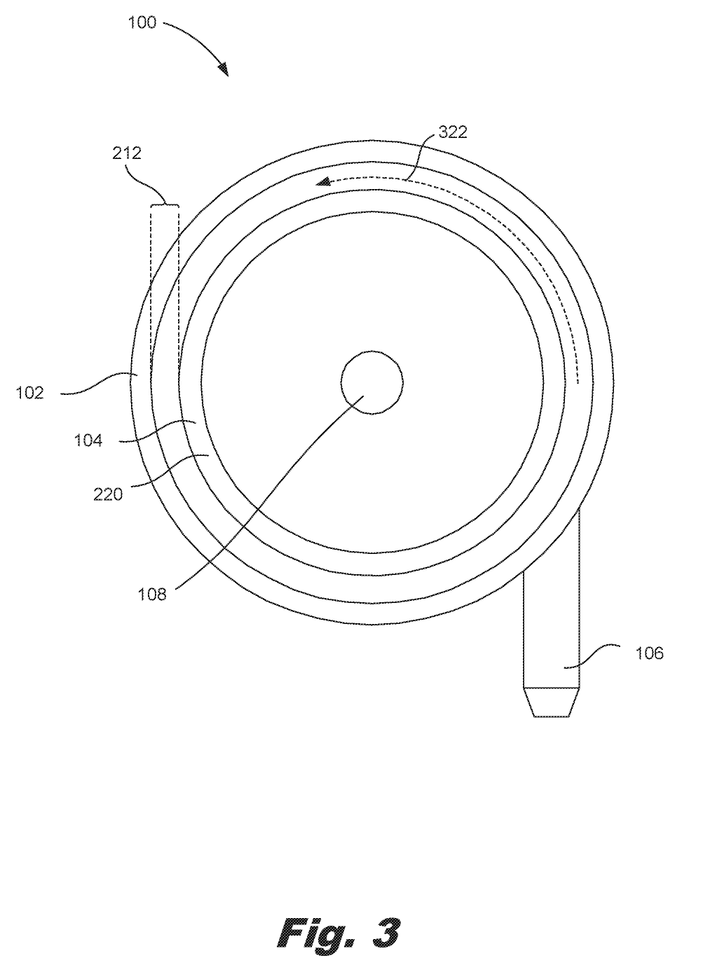

FIG. 3 is a top cross-sectional view of the device (100) for coalescing a frothy fluid with the lid (FIG. 1, 112) removed, according to one example of the principles described herein. Specifically, FIG. 3, is a cross-sectional view taken along the line A from FIG. 2. As described above, when inserted into the housing (102), a gap (212) exists between the housing (102) wall and the filter (104). When the housing (102) and the filter (104) are cylindrical, the gap (212) may be an annular gap (212). It is through this gap (212) that the frothy fluid received from the inlet port (106) is driven, as indicated by the arrow (214).

The sizing of the gap (212) may be such that pressure is exerted on the edges of the bubbles as they pass through the gap (212). In a specific example, the gap (212) may be between 0.5 millimeter and four millimeters wide. As described above, as the bubbles pop, the coalesced liquid passes through the filter (104) to an interior of the filter (104) to be drained out the outlet port (108) of the housing (102).

FIG. 4 is a view of the gap (212) between a cylindrical filter (104) and a cylindrical housing (102) of the device (100) for coalescing a frothy fluid, according to one example of the principles described herein. Specifically, FIG. 4 depicts a portion depicted in the dashed box (FIG. 2, 214). In this example, the frothy fluid enters at a low point of the gap (212) and is driven around and up the gap (212) as indicated by the arrows (FIG. 2, 216) in FIG. 2. As described above, the gap (212) is spaced such that bubbles (424-1, 424-2, 424-3, 424-4) that form the froth are stacked single-file in the gap (212). Forming the gap (212) as described provides a shortened drain for the fluid, thus speeding up the thinning of the bubbles (424). The stacking of the bubbles (424) also increases the effect of gravity when draining the resulting coalesced fluid. The gap (212) may be sized to exert pressure on the bubble (424) walls. Doing so, abrades the bubbles (424) against the rough porous surface of the filter (104), thus causing rupture of the bubble (424) surface. Once the bubbles pop, the resultant coalesced liquid is passed through to the center of the filter (104) as indicated by the arrows (428-1, 428-2, 428-3, 428-4) and the resultant air is passed upward as indicated by the arrow (426) to be ultimately vented out the air vent (FIG. 1, 110).

Having a single layer of bubbles (424) between the filter (104) and the housing (102) shortens the drain path of each bubble (424) in the froth. In this device (100), the coalesced fluid can drain rapidly through the filter (104) as indicated by the arrows (428). The path through the gap (212) also increases the rate at which the bubbles (424) pop, as bubbles (424) that are higher in the device (100) are dryer due to the increased height. Accordingly, the size of the device (100) both in diameter and height, affect how the bubbles (424) will dissipate and may be selected based on the operational characteristics of the system and material properties of the fluid.

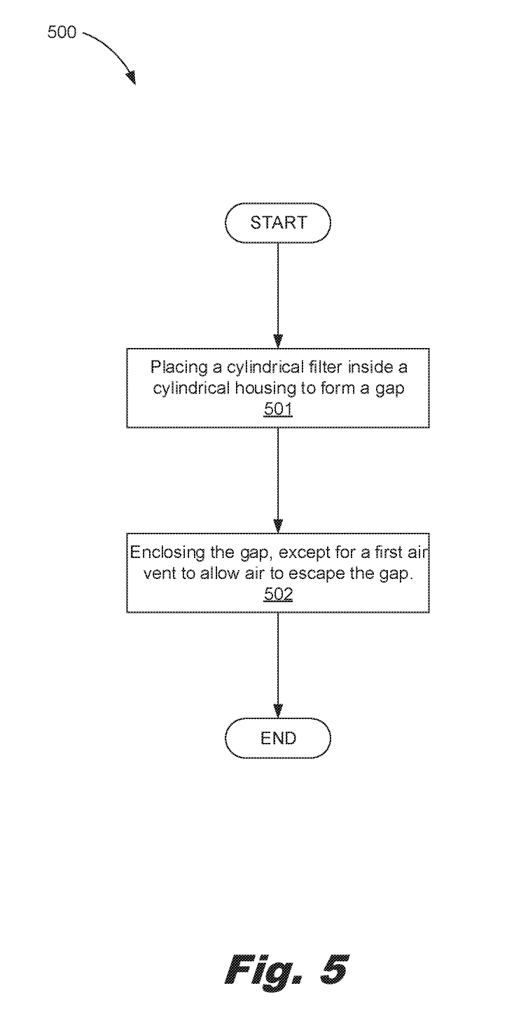

FIG. 5 is a flowchart of a method (500) for forming a device (FIG. 1, 100) for coalescing a frothy fluid, according to one example of the principles described herein. According to the method (500), a cylindrical filter (FIG. 1, 104) is placed (block 501) inside a cylindrical housing (FIG. 1, 102). Specifically, the cylindrical filter (FIG. 1, 104) is placed such that an outside diameter of the cylindrical filter (FIG. 1, 104) is separated by an annular gap (FIG. 2, 212) from an inside diameter of the cylindrical housing (FIG. 1, 102). This gap (FIG. [symbol] 212) defines a travel path of the frothy fluid. This cylindrical path provides a large surface area for the bubbles (FIG. 4, 424) of the froth to abrade against. Moreover, as the bubbles are increasing in height, the bubbles (FIG. 4, 424) begin to dry up, thin, and coarsen such that they break up as they travel upwards. The selection of the cylindrical filter (FIG. 1, 104) inserted into the cylindrical housing (FIG. 1, 102) is based on many factors such as fluid dynamics, operational pressures, system capacity, filter (FIG. 1, 104) size, filter (FIG. 1, 104) mesh size etc. Accordingly, a filter that has been selected based on any number of these, or other criteria is placed (block (501) into the cylindrical housing (FIG. 1, 102).

As described above, as froth bubbles (FIG. 4, 424) burst, the coalesced fluid passes through the filter (FIG. 1, 104) and drains out the outlet port (FIG. 1, 108) and the air rises. To direct the path of the air upwards and as desired, the gap (FIG. 2, 212) is enclosed (block 502). In one example, enclosing (block 502) the gap (FIG. 2, 212) includes sealing the cylindrical filter (FIG. 1, 104) against annular ridges (FIG. 3, 318) of the housing (FIG. 1, 102). These annular ridges (FIG. 3, 318) ensure that all coalesced fluid travels down through the filter (FIG. 1, 104) and a slot that defines the first air vent (FIG. 2, 220) in one of the annular ridges (FIG. 3, 318-2) ensures that any air resultant from a bubble (FIG. 4, 424) burst evacuates through the top.

Assembling the device (FIG. 1, 100) as described herein allows for two exits, one for coalesced fluid through the filter (FIG. 1, 104) and out the outlet port (FIG. 1, 108) and a second for air out the air vents (FIG. 2, 220, FIG. 1, 110). Thus, a liquid/air mixture is continuously separated into liquid and air components, and done so in real-time so as to not have a periodic lag or delay.

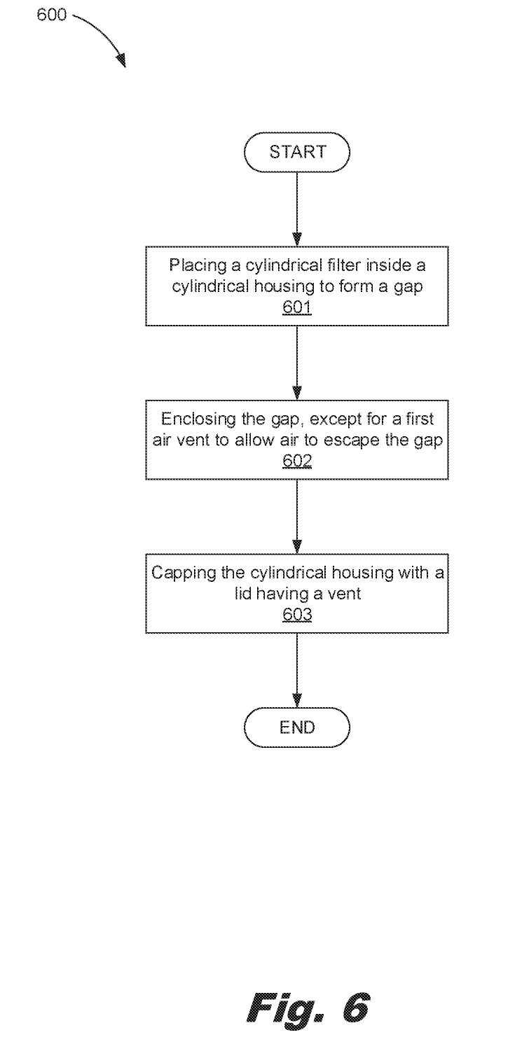

FIG. 6 is a flowchart of a method (600) for forming a device (FIG. 1, 100) for coalescing a frothy fluid, according to another example of the principles described herein. First, the cylindrical filter (FIG. 1, 104) is placed (block 601) inside a cylindrical housing (FIG. 1, 102). This may be performed as described above in regards to FIG. 5. As described above in some examples, the filter (FIG. 1, 104) may be formed of a metal material that is rolled over and has a resultant seam (FIG. 1, 103). In one example, the filter (FIG. 1, 104) may be aligned such that the seam (FIG. 1, 103) is at least 270 degrees from the input port (FIG. 1, 106) in a direction of fluid flow around the filter (FIG. 1, 104). Doing so increases the used surface area of the filter (FIG. 1, 104) before the bubbles interact with the seam (FIG. 1, 103), which seam (FIG. 1, 103) can generate additional bubbles (FIG. 4, 424). The gap (FIG. 2, 212) is then enclosed (block 602). This also may be performed as described above in regards to FIG. 5.

With the cylindrical filter (FIG. 1, 104) disposed within the housing (FIG. 1, 102), the housing (FIG. 1, 102) is capped (block 603) with a lid (FIG. 1, 112). The lid (FIG. 1, 112) has the aforementioned second air vent (FIG. 1, 110) to allow separated air to escape. In some examples, the lid (FIG. 1, 112) has an air-tight seal such that the air escapes just through the air vents (FIG. 1, 110, FIG. 2, 220). Accordingly, the air vents (FIG. 1, 110, FIG. 2, 220) can be sized so as to allow a desired pressure within the device (FIG. 1, 100). In other words, an air-tight seal of the lid (FIG. 1, 112) ensures that any air escape is through desired portions, i.e., the air vents (FIG. 1, 110, FIG. 2, 220), and so that a desired pressure can be maintained in the device (FIG. 1, 100). Capping (block 603) the device (FIG. 1, 100) with a lid (FIG. 1, 112) allows for an internal pressure to be set to achieve a desired flow of outlet ink out the outlet port (FIG. 1, 108).

FIGS. 7A-7C are diagrams of a lid (112) of the device (FIG. 1, 100) for coalescing a frothy fluid, according to one example of the principles described herein. As described, the lid (112) may include the second air vent (110) to allow air resultant from the dissipation of froth bubbles to escape. The size of the second air vent (110) may be based on the operational characteristics of the system. For example, if the second air vent (110) is too small, the internal backpressure within the housing (FIG. 1, 102) increases and may impact the operation of the device (FIG. 1, 100).

In some examples, the second air vent (110) exposes the interior of the housing (FIG. 1, 102) to atmospheric pressure. For example, as depicted in FIG. 7A, the air vent (110) may be coupled to a labyrinth (730) to allow the escape of the air. In this example, a small second air vent (110) is coupled to a channel, i.e., labyrinth (730) that has a small cross-sectional area and many turns. A label (732) is then placed over the labyrinth (730). The label (732) may have water vapor transmission prevention properties. That is it may be a polymer barrier, or a metalized layer barrier such that water doesn't transmit through it quickly. In this example, as air passes through the second air vent (110) and goes through the channel, this highly humidified air mixes with ambient air at the other end and slows down the water vapor transmission.

In another example, the second air vent (110) can maintain a greater than atmospheric pressure within the housing (FIG. 1, 102). For example, as depicted in FIG. 7B, an oleophobic membrane (734) or plug is placed over the second air vent (110) to allow the escape of air but to prevent the escape of fluid. Using the oleophobic membrane (734) or plug allows for a greater than atmospheric pressure to be maintained within the housing (102). In yet another example, both the labyrinth (730) and the oleophobic membrane (734) may be used as indicated in FIG. 7C.

Using such a device for coalescing a frothy fluid 1) allows for real-time, and not delayed, batched, or periodic, dispersal of froth from a fluid; 2) is passive in that it doesn't rely on sensors, or other moving components to dissipate the froth; 3) actively promotes the dissipation of froth, rather than allowing the froth to dissipate as merely a function of time; 4) improves froth-dissipation efficiency thereby enhancing the operation of a system that processes a fluid prone to froth accumulation; 5) improves the accuracy of certain system sensors, and 6) accommodates faster operations of a fluid-processing system by providing a continuous real-time defrothing of a frothy fluid. However, it is contemplated that the devices disclosed herein may provide useful in addressing other matters and deficiencies in a number of technical areas. Therefore the systems and methods disclosed herein should not be construed as addressing any of the particular matters.

The preceding description has been presented to illustrate and describe examples of the principles described. This description is not intended to be exhaustive or to limit these principles to any precise form disclosed. Many modifications and variations are possible in light of the above teaching.

What is claimed is:

1. A device for coalescing a frothy fluid comprising:
a housing;
a filter disposed within the housing, wherein:
an outside surface of the filter is separated from an inside surface of the housing by a gap; and
the filter is sealed against the housing to enclose the gap;
an inlet port to drive incoming frothy fluid through the gap;
an outlet port to drain coalesced fluid produced as bubbles in the frothy fluid dissipate; and
a first air vent to allow air to escape the gap.

2. The device of claim 1, wherein the fluid is ink.

3. The device of claim 1, wherein the gap is between 0.5 millimeter (mm) and four mm wide.

4. The device of claim 1, wherein the inlet port is aligned with a bottom of the filter disposed within the housing such that the frothy fluid enters the gap perpendicular to pores in the filter.

5. The device of claim 1, wherein the first air vent maintains a greater than atmospheric pressure within the housing.

6. The device of claim 1, wherein the first air vent exposes the interior of the housing to atmospheric pressure.

7. The device of claim 1, further comprising a lid to cap the housing, wherein the lid comprises a second air vent.

8. A method for forming a device for coalescing a frothy fluid comprising:
placing a cylindrical filter inside a cylindrical housing such that an outside diameter of the cylindrical filter is separated by an annular gap from an inside diameter of the cylindrical housing, wherein:
a frothy fluid travels upward through the annular gap; and
the frothy fluid separates into coalesced fluid and air;
enclosing the gap except for a first air vent to allow air to escape the gap.

9. The method of claim 8, further comprising capping the cylindrical housing with a lid having a second air vent to allow separated air to escape the cylindrical housing.

10. The method of claim 9, wherein the first air vent is circumferentially located at least 180 degrees relative to an inlet port on the cylindrical housing.

11. A device for coalescing a frothy fluid comprising:
a cylindrical housing;
a cylindrical filter disposed within, and separated from, the cylindrical housing to form an enclosed annular gap, wherein the cylindrical filter is to:
dissipate bubbles in the frothy fluid; and
allow passage of coalesced fluid to an interior of the cylindrical filter;
an inlet port to drive incoming frothy fluid perpendicular to pores in the cylindrical filter and upwards through the enclosed annular gap;
an outlet port to allow drainage of the coalesced fluid;
a first air vent to allow air to escape the enclosed annular gap; and
a lid having a second air vent to allow the escape of air resulting from defrothing the frothy fluid.

12. The device of claim 11, wherein the cylindrical housing comprises a number of annular ridges to form the enclosed annular gap, at least one of the number of annular ridges having a slot to define the first air vent.

13. The device of claim 11, wherein the second air vent comprises an oleophobic layer to allow the escape of air while preventing the escape of fluid.

14. The device of claim 11, wherein the air vent comprises a labyrinth to control the water vapor transmission rate (VVVTR) to and from the cylindrical device.

15. The device of claim 11, wherein the outlet port is disposed on a lowest point of drainage of the housing and disposed on an interior of the cylindrical filter
